(19) United States
(12) Patent Application Publication
(10) Pub. No.: US 2019/0014840 A1
(43) Pub. Date: Jan. 17, 2019

(54) PERSPIRATION-ABSORBING FACE PAD FOR VIRTUAL REALITY HEAD MOUNTED DISPLAY

(71) Applicants: Henry F. Fung, San Diego, CA (US); Louis A. Oddo, Carlsbad, CA (US)

(72) Inventors: Henry F. Fung, San Diego, CA (US); Louis A. Oddo, Carlsbad, CA (US)

(21) Appl. No.: 15/647,274

(22) Filed: Jul. 12, 2017

(51) Int. Cl. A41D 27/12; A41G 7/00; G06F 1/16

(52) U.S. Cl. CPC A41D 27/12; G06F 1/163; A41G 7/00

(57) ABSTRACT

The present invention relates to a novel application of perspiration absorption from the face of a user wearing a virtual reality Head Mounted Display (HMD). More particularly, the invention relates to the use of perspiration absorbing materials ergonomically fitted to the user's face to provide a sanitary shield between the user's face and the worn virtual reality HMD. Due to the invention's ergonomic design, perspiration is prevented from entering the user's eyes preventing eye irritation while wearing a virtual reality HMD during vigorous usage. Since the face pad is designed to conform to a general user's face, it is not specific to any make or model of HMD and thus can be used with HMD's from any manufacturer.

### CROSS-REFERENCE TO RELATED APPLICATIONS

This application claims priority to U.S. Provisional Application Ser. No. 62/363,113 filed 15 Jul. 2016 (“Parent Provisional”), and hereby claims benefit of the filing dates thereof pursuant to 37 CFR § 1.78(a)(4). The subject matter of the Parent Provisional, in its entirety, is expressly incorporated herein by reference.

### FIELD OF THE INVENTION

The present invention relates to a novel application of perspiration absorption from the face of a user wearing a virtual reality Head Mounted Display (HMD). More particularly, the invention relates to the use of perspiration absorbing materials ergonomically fitted to the user's face to provide a sanitary shield between the user's face and the HMD. Due to the invention's ergonomic design, perspiration is prevented from entering the user's eyes preventing eye irritation while wearing a virtual reality HMD during vigorous active use.

### BACKGROUND

As personal computer graphical processing power increases while component costs decrease, virtual reality gaming systems are becoming more affordable to the average personal electronics consumer. Large corporations are investing heavily in developing and actively selling virtual reality systems aimed at the computer gaming industry. The ability to play virtual reality games between geographically separated users over the Internet already exists. In addition to gaming, emerging virtual reality applications include virtual tourism, virtual house hunting, remote sensing, and others yet to be conceived. The virtual reality market is poised to experience growth analogous to that of the mobile digital game market which is just under $100B worldwide in 2016.

Current virtual reality systems require the user to wear a pair of stereo image projectors on their head to enable high definition visualization of the virtual environment in full three dimensions (3D). It is this high definition 3D visualization experience that gives the user a feeling of immersion in the virtual world. The Head Mounted Display (HMD) that provides the 3D visualization must seal out external light sources to create the high definition immersive experience.

The light seal of the virtual reality HMD has the side effect of also creating a vapor and thermal seal within the space between the HMD and the face of the user causing the user's face to perspire. The perspiration can become profuse if the user is engaged in a vigorous interactive game or application. Perspiration from the user's face can enter the user's eyes causing irritation and halting usage. The perspiration can also build up on the inside surface of the HMD as well as saturate interface material, typically a flexible soft porous foam, that fits between the HMD and the user's face.

If multiple users desire to share a single HMD in a group setting, there are sanitary issues involved. Cleaning the HMD takes time and slows usage. Most HMD manufactures provide a HMD-to-user interface made of a soft porous foam. The foam interface between the HMD and the user's face becomes saturated with perspiration, is difficult to clean and dry, and deteriorates with repeated use. Rubberized or silicon interfaces are available but they are expensive and also take time to clean. While the foam interfaces absorb perspiration, the rubberized and silicon interfaces are not absorbent and permit sweat to build up and enter the user's eyes causing irritation and halting usage.

### BRIEF SUMMARY OF THE INVENTION

In the preferred embodiment of the present invention, a perspiration absorbing face pad made of perspiration absorbing material is worn on the face of the user providing a sanitary shield between the user's face and the virtual reality HMD as well as preventing perspiration from entering the user's eyes.

In one embodiment, the perspiration absorbing face pad can be made of washable material enabling multiple uses. In another embodiment, the face pad can be made of disposable materials enabling cost effective single use applications. Other embodiments include, but are not limited to, none, single, or multiple straps that hold the face pad in place on the user's head. The perspiration absorbing face pad can also be used with an optional HMD interface made of foam, silicon, or any other soft flexible material.

### BRIEF DESCRIPTION OF THE DRAWINGS

FIG. 1 shows the perspiration absorbing face pad from the front.

FIG. 2 shows the perspiration absorbing face pad and its relationship to a generic virtual reality HMD and its optional foam interface.

### DETAILED DESCRIPTION OF THE INVENTION

In the preferred embodiment of the present invention, a perspiration absorbing face pad made of perspiration absorbing material is worn on the face of the user providing a sanitary shield between the user's face and the interface of the virtual reality HMD. Due to its ergonomic design, the perspiration absorbing face pad also prevents perspiration from entering the user's eyes. Since the face pad is designed to conform to a general user's face, it is not specific to any make or model of HMD and thus can be used with an HMD from any manufacturer.

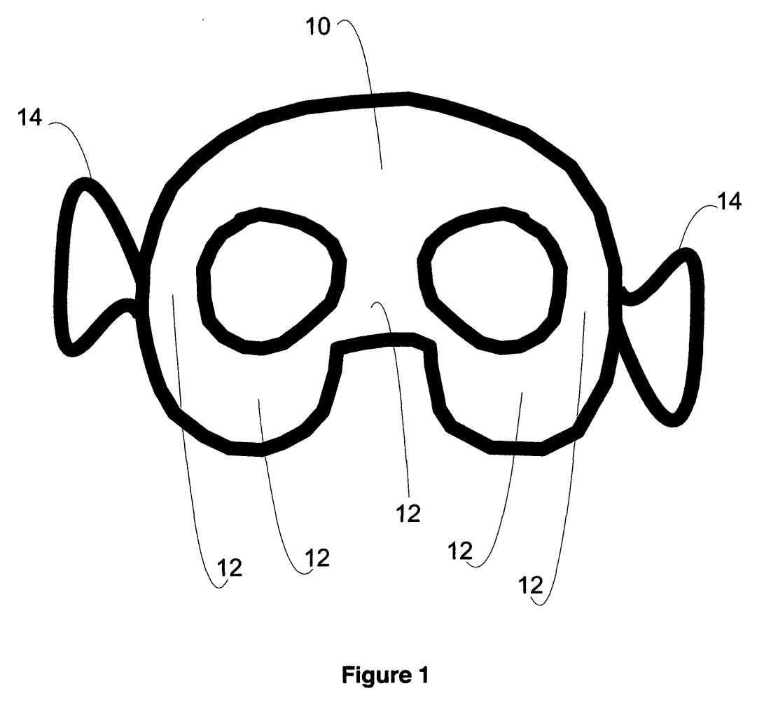

FIG. 1 is an illustration of the perspiration absorbing face pad from the front. The wide amount of padding on the top is designed to provide effective perspiration absorption on the user's forehead 10. Padding around the sides of the eye openings, over the bridge of the nose, and directly under the eyes is designed to prevent perspiration from building up inside the HMD and entering the user's eyes causing irritation during usage 12. Straps attached to the sides of the face pad 14 are designed to fit around the back of the user's ears keeping the pad in place while putting on and removing the virtual reality HMD. Other embodiments of the face pad include, but are not limited to, a single strap that fits around the back of the user's head, multiple straps around the back of the head, and no straps at all.

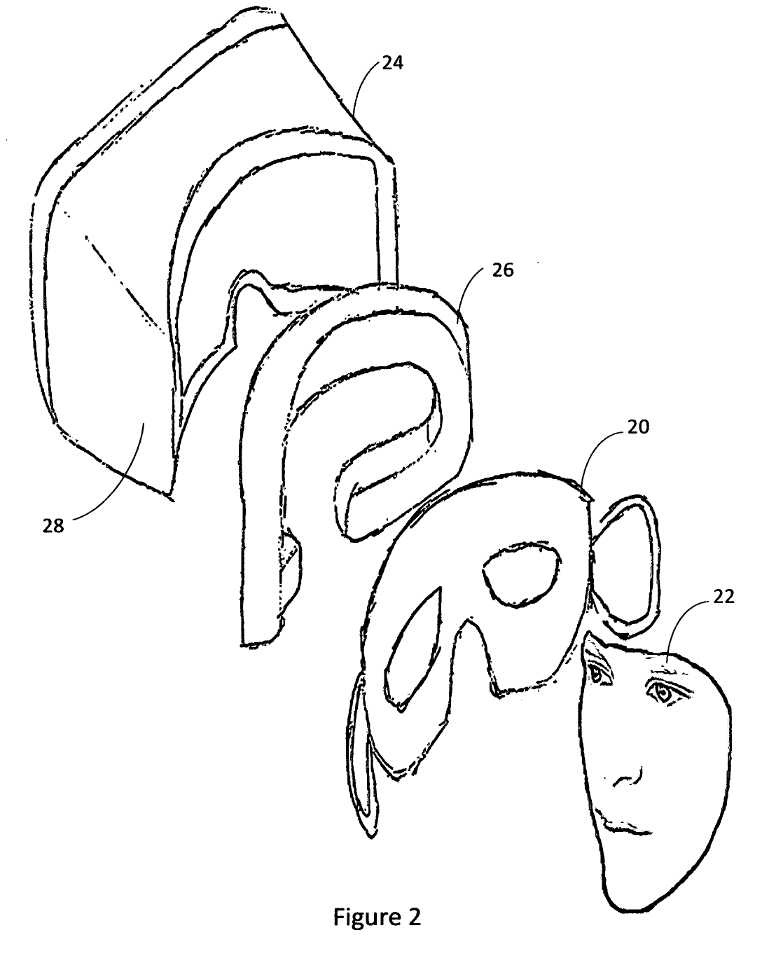

FIG. 2 illustrates how the perspiration absorbing face pad 20 provides a sanitary shield between the user's face 22, and the virtual reality HMD 24. The interface 28 of the virtual reality HMD 24 creates a thermal and vapor seal that causes the user to perspire. The interface 26 is part of the virtual reality HMD 24 and can be made from any soft flexible material and is typically a porous foam. Since the perspiration absorbing face pad 20 is designed to conform to the generic user's face 22, it is independent of any specific HMD design 24 and can be use with any HMD from any manufacturer with or without the interface 26.

What is claimed is:

1. A perspiration absorbing face pad comprising: perspiration absorbing material, shaped to fit a human face, covering the face from the top of the forehead to the cheekbones, covering the cheekbones, covering the bridge of the nose and sides of the face between the eye sockets and temples, with openings for two eyes.

2. The perspiration absorbing face pad of claim 1 further comprising: zero or more straps attached to the sides of the perspiration absorbing face pad in configurations that hold the perspiration absorbing face pad to the user's head and face.

3. The perspiration absorbing face pad of claim 1 further comprising: washable perspiration absorbing material enabling multiple uses or alternatively, disposable perspiration absorbing material for a single use.
